(19) United States
(12) Patent Application Publication
(10) Pub. No.: US 2002/0180607 A1
(43) Pub. Date: Dec. 5, 2002

(54) Method and apparatus for detection of wood destroying insects and damage evaluation using microwaves

(76) Inventors: Dimitri Donskoy, Hoboken, NJ (US); Nikolay Sedunov, Hoboken, NJ (US)

Correspondence Address: SELITTO, BEHR & KIM, 203 MAIN STREET, METUCHEN, NJ, 08840-2727, US

(21) Appl. No.: 09/873,118

(22) Filed: Jun. 1, 2001

(51) Int. Cl. G08B 23/00

(52) U.S. Cl. 340/573.2; 43/132.1; 73/865.8

(57) ABSTRACT

A method and apparatus is provided for nondestructive testing and evaluation of wood and wooden structures for insects using microwave radiation. The apparatus includes a microwave generator, a receiver, an antenna for sending and receiving signals, a signal processor for processing the received signals and a display. The detection method includes generating and sending a microwave signal, receiving a reflected signal, and processing and evaluating the received signal. The evaluation method includes sweeping the frequency of the generated signal to determine the maximum received signal, and comparing the maximum received signal to a standard deviation between the maximum received signal and the standard indicates damage and extent of the deviation indicates the extent of the damage. Preferably, the apparatus is hand-held and the method includes moving the apparatus about a structure to be tested.

### BACKGROUND OF THE INVENTION

1. Field of the Invention

This invention generally relates to nondestructive testing and evaluation of wood and wooden structures for biological and environmental degradation and damage, and more particularly, to a method and apparatus for detecting wood destroying insects and evaluating damage caused thereby, using microwave radiation.

2. Related Art

Biological attacks caused by wood destroying fungus, borers, termites, carpenter ants, and the like are a major problem for structures made wholly or partially of wood. Such attacks can cause considerable damage to wooden structures.

Known methods for the damage assessment of wooden structures and detection of wood damaging organisms are mostly based on visual inspection and mechanical collectors (traps) of wood destroying insects. There are a few patents that discuss using the acoustic emissions from the insects to detect the insects, but there is no evidence of successful implementation of this technique in practice. In fact, only visual inspection is currently performed to detect damage. In most cases the visual inspection detects only damage, not the presence of the insects. Such inspection is limited only to assessable parts of the structure. As a result, most of the structure is not inspected. Moreover, even if the damage was visually detected and the structure was treated, there is no means to ensure the effectiveness of the treatment, since there is no means of determining the presence of the still living insects in the structure. Similarly, there is no known effective method for evaluating damage caused by wood destroying insects other than the visual inspection thereof.

Accordingly, what would be desirable, but has not yet been developed, is a reliable method and apparatus for detecting wood destroying insects in structures, and for evaluating the damage caused thereby and by other biological attacks.

### OBJECTS AND SUMMARY OF THE INVENTION

It is an object of the present invention to provide a method and apparatus for detecting wood destroying insects in wood and wooden structures.

It is another object of the present invention to provide a method and apparatus for detecting wood destroying insects in wood and wooden structures which is non-destructive.

It is a further object of the present invention to provide a method and apparatus for detecting wood destroying insects in wood and wooden structures which apparatus is in the form of hand-held probe.

It is even a further object of the present invention to provide a method and apparatus for detecting wood destroying insects in wood and wooden structures that detects such insects based on motion and electric conductivity.

It is still a further object of the present invention to provide a method and apparatus for detecting wood destroying insects in wood and wooden structures which is capable of detecting insects in otherwise inaccessible areas of the structures.

It is even a further object of the present invention to provide a method and apparatus for evaluating damage caused by biological attacks, including, but not limited to fungus and wood destroying insects.

The present invention relates to a method and apparatus for nondestructive testing and evaluation of wood and wooden structures for degradation and damage using microwave radiation. The apparatus includes a microwave generator, a receiver, an antenna for sending and receiving signals, a signal processor for processing the received signals and an output such as a display. The method includes generating and sending a microwave signal, receiving a reflected signal, and processing and evaluating the received signal. Preferably, the apparatus is hand-held and the method includes moving the apparatus about a structure to be tested.

Detection is based on the motion and electrical conductivity of wood destroying insects. Insects are comprised of electrolyte (electrically conductive) material while wood is dielectric. This creates high contrast reflectivity for microwave radiation. Also, insects are living organisms in constant motion. The apparatus detects very small motions (fraction of mm per second), thus allowing for detection of living (moving) organisms in static material. A stimulator may be used for stimulating insect movement. Damage evaluation is based on changes to the dielectric properties of wood caused by damage thereto.

### BRIEF DESCRIPTION OF THE DRAWINGS

Other important objects and features of the invention will be apparent from the following Detailed Description of the Invention taken in connection with the accompanying drawing in which:

FIG. 1 is a schematic drawing of the detector of the present invention.

FIG. 2 is a graph of the output sensor of the experimental setup shown in FIG. 2 with and without insects.

FIG. 3 shows another embodiment of the present invention.

### DETAILED DESCRIPTION OF THE INVENTION

The present invention relates to a method and apparatus for nondestructive testing and evaluation of wood and wooden structures for degradation and damage using microwave radiation. By wooden structures it is meant any structure made wholly or partially of wood, including, but not limited to, houses, building, bridges, other wooden structures, wooden frames, utility poles, piles, etc. Degradation and damage may be due to biological attack, such as fungus, borers, termites, or other insects. Degradation, damage and/or other deterioration is collectively referred to herein as damage. Detection of wood destroying insects is based on the conductivity and constant motion of the insects. Insects are comprised of electrolyte (conductive) material while wood is dielectric. This creates high contrast reflectivity for microwave radiation. Also, insects are living organisms in constant motion. The present invention detects very small movements (fraction of mm per second), thus allowing for detection of living (moving) organisms in static material. Damage evaluation is based on changes to the dielectric properties of wood caused by damage thereto such as by biological attacks.

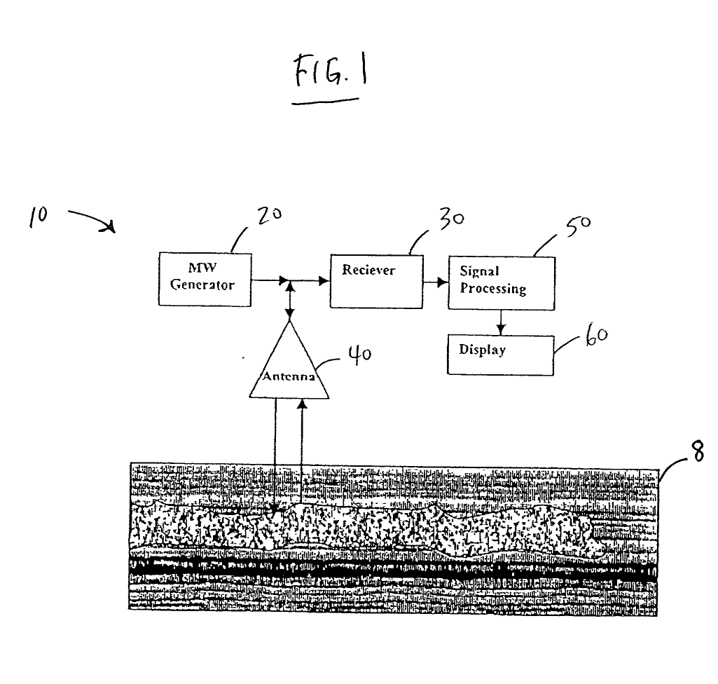

As can be seen in FIG. 1, the apparatus of the present invention, generally indicated at 10, includes a microwave generator 20, a receiver 30, an antenna 40 for sending and receiving signals, a signal processor 50 for processing the received signals and a display 60. Preferably, the apparatus is hand-held and is moved along the wooden structure 8 being tested. Microwave signals (radiation) are generated by generator 20. The generator 20 does not have to be particularly strong; in testing it was found that a 10 mW generator was sufficient. The generated signal is constantly sent by the antenna 40, which also constantly receives a reflected signal. The signals are received by receiver 30 and processed by signal processor 50. Optionally, the apparatus 10 can include a display 60 for displaying the results. Alternatively, the apparatus 10 could merely emit an audio or visual alarm indicating the presence of insects.

The method includes generating and sending a microwave signal, receiving a reflected signal, and processing and evaluating the received signal. It has been found that a generated signal having a frequency of between 0.5 and 50 Ghz is suitable. The method could be employed with a hand-held unit wherein the unit is moved about a structure to be tested. Alternatively, the apparatus could be stationary and allowed to operate for a given time to cover a given area. In such a case, the apparatus could be attached to the wooden structure being tested for a short period of time, or left attached for a longer time for long term monitoring.

The apparatus 10 could additionally include a stimulator for stimulating insect movement to make detection easier. The stimulator could be based on vibration, ultrasound, electromagnetic radiation, heating, etc. Preferably, a stimulator would be used prior to or during the application of the microwave probe.

### EXAMPLES

An examplary application of the invention was conducted. In the example, tests were performed with live ants contained within a plastic box and dead ants which were attached to an adhesive. The ants were placed beneath a wooden board.

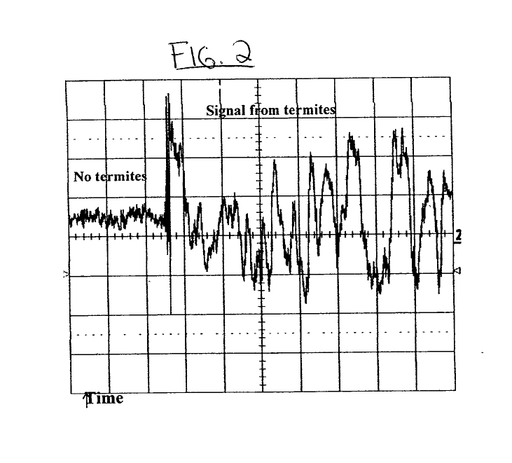

As shown in FIG. 2, where there is no motion, i.e. dead ants, there is basically no output signal from the probe. However, slight motion of live insects resulted in appreciable output signals.

In another examplary case, live termites were put into a plastic container and one-inch wood board was used to separate the probe from the container. A significant output, similar to that shown in FIG. 2, was achieved for live termites as opposed to the absence of termites.

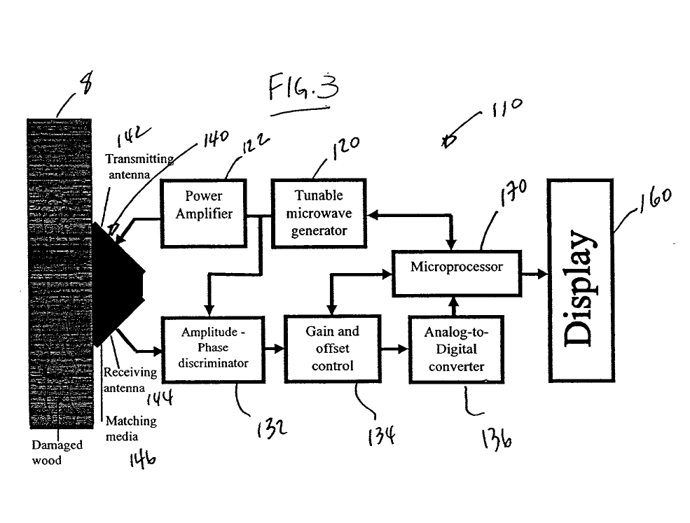

FIG. 3 shows another embodiment of the present invention generally indicated at 110. The device includes an antenna 140 having a transmitting portion 142 and a receiving portion 144. The transmitting and receiving portions can be interconnected with a circulator, not shown. Alternatively, two separate transmitting and receiving antennas can be utilized. Transmitting antenna 142 radiates the tested wooden structure 8 with a probing microwave energy. The microwaves penetrate into the tested wooden structure 8 via matching media 146 having a similar properties to wood dielectric properties. Inhomogeneities in the wood, such as damage and conductive insects, cause reflection of the probing signal back to the receiving portion 144 of antenna 140. The received signal is processed for damage evaluation and moving insect detection. A tunable microwave generator 120 is controlled by a microprocessor 170. The tunable microwave generator 120 interconnects with power amplifier 122 to deliver a signal to the antenna 140. The receiving portion 144 of antenna 140 outputs a signal to an amplitude and phase discriminator 132 which is interconnected with tunable microwave generator 120. The signal is then sent to gain and offset control 134 which is interconnected with microprocessor 170 and then sent to analog-to-digital converter 136 and then to microprocessor 170. Finally, the output is displayed in display 160.

In the damage evaluation mode, the microprocessor 170 sweeps the frequency range of the generator 120 to find a frequency with maximum (strongest) received signal. The antenna is basically coupled to the wood and the received signal depends on the dielectric properties of the wood. Because damage to wood changes the dielectric properties of wood, the frequency deviation from a precalibrated value (which is determined using undamaged wood) indicates the presence and magnitude of damage in the structure 8. The greater deviation the greater the damage.

In the detection mode, the microprocessor 170 sets the fixed frequency of the generator 120. This frequency corresponds to the maximum received signal, for greatest sensitivity. If there are moving reflectors (insects) the received signal contains amplitude and phase variations due to the motion. These variations are extracted with the amplitude-phase discriminator 132 and sent to gain and offset control device 134, which adjusts amplification and offset voltage for optimum evaluation of the signal sent to microprocessor 170. The microprocessor 170 calculates the standard deviation of the received signal. When deviation exceeds a threshold level, predetermined during sensor calibration, the microprocessor 170 sends a live insect message to display 160. The display can be a simple indicator, i.e. a red, green indicator, a sound indicator, or a more sophisticated LED or LCD display.

By evaluating damage and detecting insects the present invention provides an integrated approach with built in confirmation. For example, if there is a modest indication of insect presence, the presence of damage serves to confirm that insects are present. Similarly, sweeping the frequency for damage evaluation to find the maximum received signal allows for subsequent insect detection at the frequency having maximum sensitivity. Further detecting insects after finding damage serves to confirm damage.

Having thus described the invention in detail, it is to be understood that the foregoing description is not intended to limit the spirit and scope thereof. What is desired to be protected by Letters Patent is set forth in the appended claims.

What is claimed is:

1. A method of detecting insects in wood and wood structures comprising:
generating a microwave signal in proximity to wood to be tested;
receiving a reflected signal from insects in the wood;
analyzing the reflected signal for phase and amplitude variations indicating a presence of moving insects; and
issuing an alarm to indicate the presence of insects.

2. The method of claim 1 wherein the alarm is visually displayed.

3. The method of claim 1 further comprising moving the microwave signal about the wood being tested.

4. The method of claim 3 wherein the method employs a hand-held device and the method further comprises moving the hand-held device about the wood being tested.

5. The method of claim 1 further comprising stimulating insect movement to enhance detection.

6. The method of claim 1 further comprising tuning the frequency of the microwave signal to receive maximum received signal for maximum sensitivity.

7. The method of claim 6 wherein damage is detected by comparing the frequency of the maximum received signal to a predetermined frequency and the frequency deviation indicates the presence of damage.

8. The method of claim 7 wherein the degree of deviation corresponds to the degree of damage.

9. A method for detecting damage in wood comprising:
generating a microwave signal in proximity to wood to be tested;
sweeping the frequency of the signal over a range;
determining a frequency having a maximum received signal; and
comparing the frequency of the maximum received signal with a precalibrated value;
wherein, a deviation between the frequency of the maximum received signal and a precalibrated value indicates the presence of damage.

10. The method of claim 9 further comprising evaluating the degree of the deviation to determine the extent of damage.

11. The method of claim 9 further comprising using the maximum received signal to detect the presence of insects in wood.

12. The method of claim 11 further comprising evaluating phase and amplitude deviations for detecting the presence of insects.

13. An apparatus for detecting insects in wood comprising:
a microwave signal generator;
an antenna for sending the microwave signal, and for receiving a reflected signal from moving insects in the wood;
a signal processor for processing the received signal for evaluating phase and/or amplitude variations indicating the presence of insects; and
an alarm for indicating the presence of insects.

14. The apparatus of claim 13 wherein the alarm is visible on a display.

15. The apparatus of claim 13 further comprising a stimulator for stimulating insect movement.

16. The apparatus of claim 13 wherein the antenna further comprises matching media having dielectric properties similar to wood.

17. The apparatus of claim 15 wherein the stimulator vibrates the wood to stimulate insect movement.

18. The apparatus of claim 15 wherein the stimulator heats the wood to stimulate insect movement.

19. The apparatus of claim 13 wherein the apparatus further detects damage, the apparatus comprising a tunable microwave signal generator and the frequency of the microwave signal is adjusted to determine the frequency of the maximum reflected signal received which is compared to a predetermined value and deviation therefrom indicates damage.

20. An apparatus for detecting and evaluating degradation or damage in wood and wooden structures comprising
a tunable microwave signal generator;
an antenna for sending the microwave signal, and for receiving a reflected signal;
a signal processor for processing the received signal and determining the frequency of the maximum received signal and comparing the frequency of the maximum received signal to a predetermined value; and
a display for indicating damage if the frequency of the maximum received signal deviates from the predetermined value.

21. The apparatus of claim 20 further comprising issuing an alarm if the frequency deviation exceeds predetermined thresholds.
